(19) United States
(12) Patent Application Publication
(10) Pub. No.: US 2014/0015348 A1
(43) Pub. Date: Jan. 16, 2014

(54) ELECTRIC MOTORS WITH DOUBLE LAYER FORMED COIL LAPPED WINDING

(71) Applicant: Zhesheng Li, San Jose, CA (US)

(72) Inventor: Zhesheng Li, San Jose, CA (US)

(73) Assignee: SINOELECTRIC POWERTRAIN CORPORATION, Sunnyvale, CA (US)

(21) Appl. No.: 13/549,236

(22) Filed: Jul. 13, 2012

(51) Int. Cl. H02K 3/28; H02K 15/00; H02K 3/493

(52) U.S. Cl. 310/43; 310/201; 29/596

(57) ABSTRACT

A motor comprises a stator having open slots with a double layer formed coil lapped winding and the method to manufacture thereof.

### FIELD OF THE INVENTION

The present invention relates to structures and the method of manufacturing electric motors. More specifically, the present invention relates to electric motors with a double layer formed coil lapped winding.

### BACKGROUND OF THE INVENTION

Electric motors contain a rotor (moving part) and a stator (stationary part). A force is generated to drive the electric motors through the interaction of magnetic fields and current-carrying conductors. The efficiency of the electric motors often depends on the designs of the winding on the stator.

A typical armature comprises one or more multiple phase windings. Each phase further comprises several parallel paths. Each path further comprises several coils. For a two-layer winding, each coil comprises two sides. A first side occupies top layer of the slot and the second side occupies the bottom layer of the slot. The typical armature comprises partially closed slots. The wires are inserted into the partially closed slots one by one and occupy random position in the slots. This procedure is time consuming, thereby limiting production quantities and increasing cost of manufacturing such motors.

Typically, a partially closed opening to receive the winding design is used on the motor of the electric vehicle. The drawbacks of using this design include that it is more difficult to manufacture and it takes more time for the workers to install them into the partially closed slot of the stator. In average, a skilled worker takes a whole working day to complete the insertion of the winding for two motors.

### SUMMARY OF THE INVENTION

In some embodiments of the present invention, an electric motor contains a rotor and a stator having a double layer formed coil lapped winding. The winding is able to be used on an open slot armature, which is advantageous in many aspects including higher slot fill factor, better insulation performance, lower thermal resistance between winding and armature core, shorter length of winding end turns, easier insertion of formed coils into the armature core, easier to manufacture, and better magnetic insulation between layers. This type of armature is able to be applied in synchronous machine, induction machine, and permanent magnet machines. In some embodiments, the electric motor disclosed herein is used on electric vehicles.

In a first aspect, a motor comprises a stator having a first open slot and a second open slot, a double layered winding structure having a first coil side of a first winding at a bottom position and a first coil side of a second winding at a top position of the first open slot, and a first end turn comprising a turned phase winding structure, wherein the first end turn is electrically coupled with the first coil side of the first winding and a second coil side of the first winding. In some embodiments, each of the first winding and the second winding comprise multiple conductors forming a multiple turn winding, wherein each of the conductors comprises multiple strands. In other embodiments, the second coil side of the first winding is positioned at a top position of the second open slot. In some other embodiments, the motor further comprises a third winding having a first coil side at a bottom position of the second open slot, In some embodiments, the motor further comprises a third open slot having a second coil side of the second winding positioned at a bottom position of the third open slot. In some other embodiments, the stator comprises multiple slots surrounding the stator in a circle. In some embodiments, the first winding is twisted and turned up-side-down at the first end turn. In other embodiments, the motor further comprises a second end turn connecting the first coil side of the first winding and the second coil side of the second winding forming a loop structure. In some embodiments, the motor is operated at a frequency higher than 70 Hz. In other embodiments, the motor further comprises a wedge covering an opening of the first open slot, the second open slot, the third open slot, or a combination thereof. In some other embodiments, the wedge is made of plastic, polymers, bamboo, aluminum, a semi-magnetic material, or a combination thereof. In some embodiments, the semi-magnetic material comprises epoxy and powdered steel.

In a second aspect, a motor comprises a stator comprising a first open slot and a first coil in the first open slot, wherein the first coil forms at least one block. In some embodiments, the block is substantially rectangular in shape. In other embodiments, the first coil forms a first block and a second block. In some embodiments, the first block is on top of the second block in the first open slot. In other embodiments, the first block and the second block are reverse in position when the first coil is positioned in a different open slot. In some other embodiments, the motor further comprises a second coil. In some other embodiments, the second coil is on top of the first coil in the first open slot. In some embodiments, the motor further comprises a separator between the first coil and the second coil. In other embodiments, the motor further comprises a wedge covering the opening of the first opening slot. In some other embodiments, the wedge is made of plastic, polymers, bamboo, aluminum, a semi-magnetic material, or a combination thereof. In some embodiments, the thickness of the block is less than 0.8 mm. In other embodiments, the thickness of the block is reduced to reduce a skin effect.

In a third aspect, a method of manufacturing a motor comprises placing a first coil in a lower position of a first open slot and placing a second coil in a higher position of the first open slot. In some embodiments, the first coil is in a higher position of a second open slot. In other embodiments, the second coil is in a lower position of a third open slot. In some other embodiments, the first coil is formed before placing in the first open slot. In some embodiments, the method further comprises placing a third coil in a lower position of an open slot immediate adjacent to the first open slot. In some embodiments, the motor comprises multiple open slots surrounding a stator of the motor, In other embodiments, the open slots comprise fully opening slots.

### BRIEF DESCRIPTION OF THE DRAWINGS:

FIG. 1 illustrates a front view of a stator with a double layer formed coil lapped winding in accordance with some embodiments.

FIG. 2 illustrate an end view and a top view of the winding 108 (FIG. 1) in accordance with some embodiments.

FIG. 3 illustrates a double layer winding in a slot in accordance with some embodiments.

FIG. 4A illustrates a winding manufacturing method in accordance with some embodiments.

FIG. 4B illustrates a device for manufacturing the winding in accordance with some embodiments.

FIG. 5A illustrates a two strands winding design in accordance with some embodiments.

FIG. 5B illustrates a three strands winding design in accordance with some embodiments.

### DETAILED DESCRIPTION OF THE PREFERRED EMBODIMENT:

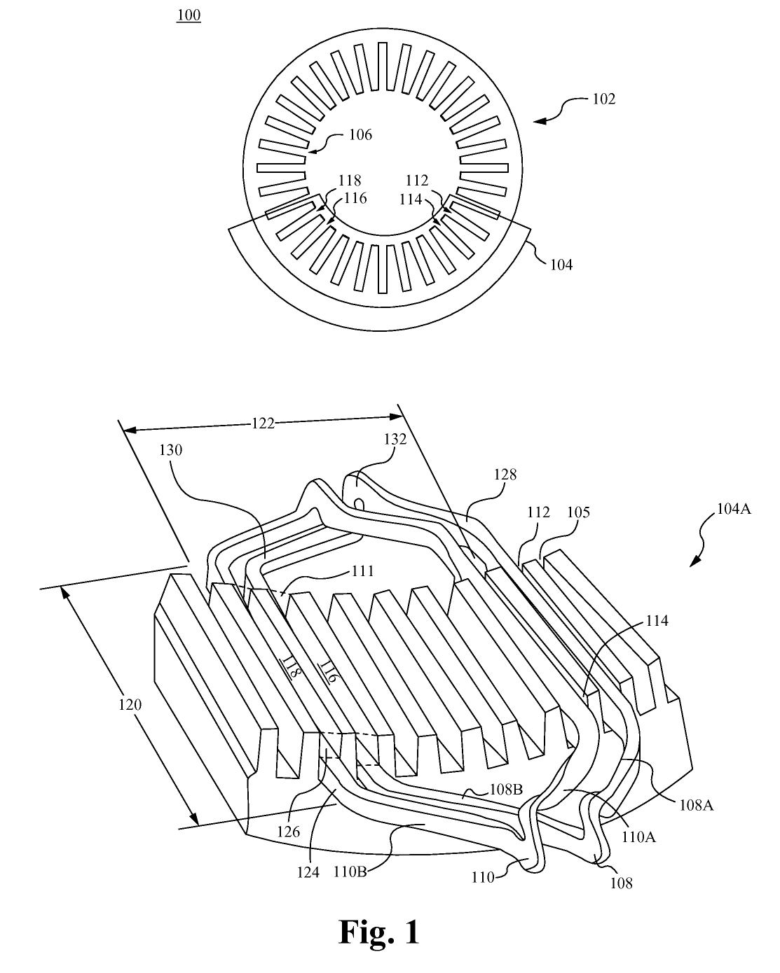

FIG. 1 illustrates a front view of a stator 102 with a double layer formed coil lapped winding in accordance with some embodiments. The stator 102 is adapted to be a part of an electric motor 100 for an electric vehicle in accordance with some embodiments. The stator 102 is able to be used in an open slot armature. The stator 102 contains a plurality of open slots 106. The open slots are configured to receive windings directly by placing or sliding into place. The section 104A is an enlarged view (at a different viewing angle) of the section 104. The stator 102 contains a plurality of coils, including a first coil 108 and a second coil 110. The coils are first wound, then formed to an appropriate site and shape, and then inserted into the slots. The first coil 108 contains a first arm 108A and a second arm 108B. Similarly, the second coil 110 is able to contain a first arm 110A and a second arm 110B. The first arm 108A of the first coil 108 is able to be located at the first slot 112 and the first arm 110A of the second coil 110 is able to be located at the second slot 114. The second arm 108B of the first coil 108 is able to be located at the third slot 116 and the second arm 110B of the second coil 110 is able to be located at the fourth slot 118. The first slot 112 is able to be an immediate slot next to the second slot 114, and the third slot 116 is able to be an immediate slot next to the fourth slot 118. The distance of the first arm 108A to the second arm 108B of the first coil 108 is able to be the same distance of the first arm 110A to the second arm 110B of the second coil 110, such that when the first arm 108A and the first arm 110A are placed in the first slot 112 and second slot 114 respectively, the second arm 108B and 110B locate in the third slot 116 and the fourth slot 118 respectively. By placing the first arm 108A in a slot adjacent to the slot for placing the first arm 110A, the first coil 108 and the second coil 110 forms a lapped structure (partially or entirely overlapping the first coil 108 and the second coil 110) because of the complete loop structure of the first coil 108 and the second coil 110.

With the coil placement described above, a first aim 111 of a 7^{th} winding is placed on top of the second arm 108B of the first coil 108, such that a double layer winding structure is formed by having an arm on top of the other. More details of the coil 108 are described in the following sections.

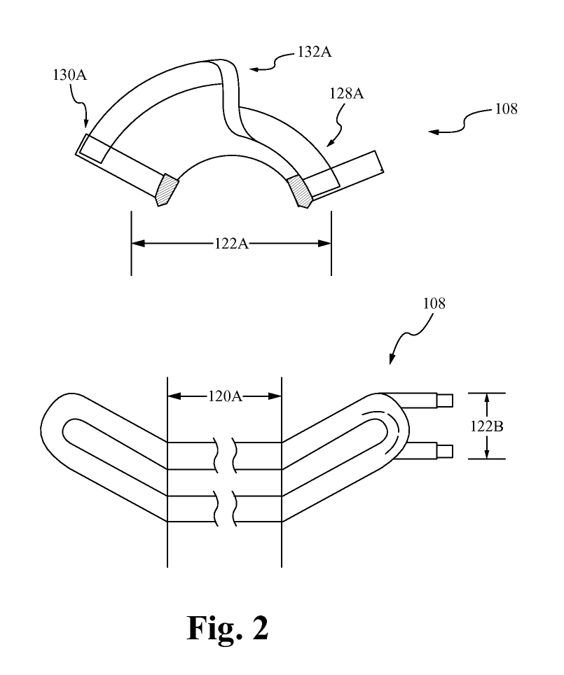

FIG. 2 illustrates an end view and a top view of the coil 108 (FIG. 1) in accordance with some embodiments. As shown in FIG. 2, section 122A is an end view of the section 122 of the coil 108 (FIG. 1). The section 122A shows an end turn of a coil end. The right end 128A, left end 130A, and center 132A in FIG. 2 correspond to the right end 128, left end 130, and center 132 in FIG. 1, respectively. As shown in FIG. 2, the left end 130A of the first coil 108 is twisted to turn at center 132A. In some embodiments, the turning is or is about 180 degrees. The section 120A in FIG. 2 illustrates the section 120 of FIG. 1, and the section 122A in FIG. 2 illustrates the section 122 of FIG. 1. The section 122B shows that the first coil 108 forms a complete loop allowing the conduction of an electric current. A person of ordinary skill in the art appreciates that the winding is able to be bent, turned, or transformed in any shape with a physical force.

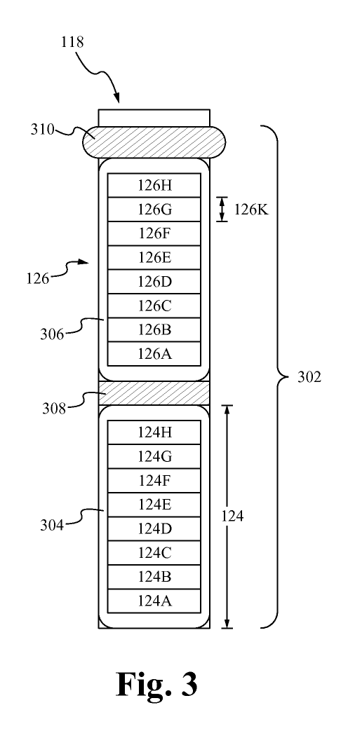

FIG. 3 illustrates a double layer winding in a slot in accordance with some embodiments. The double layered coil 302 is able to be in the slot 118 (FIG. 1) or any other slots. In some embodiments, the double layered coil 302 comprises two layers, including the upper layer 126 and the lower layer 124. The upper layer coil 126 is able to contain units of block 126A-126H. The lower layer coil 124 is able to contain units of block 124A-124H. In some embodiments, the lower layer coil 124 is wrapped by an insulation material 304, and the upper layer coil 126 is wrapped by an insulation material 306. A separator 308 is able to be inserted in between the lower layer coil 124 and the upper layer coil 126. A fixing material 310 is able to be used to seal the opening of the slot 118. The fixing material 310 is able to comprise or be made of plastic, polymers, bamboo, aluminum, semi-magnetic materials (such as epoxy and powdered steel). The wedge 308 is able to comprise pulp and paper. A person of ordinary skill in the art appreciates that any materials are able to be used as materials for the fixing material 310 (wedges) and the separator 308 so long as they are able to separate and/or isolate the two layers of coils. Further, a person of ordinary skill in the art appreciates that any number of the layers are able to be placed in the slot 118 and any other slot of the stator 102 (FIG. 1). Similarly, the units or turns of the winding (stacking units, such as 124A-124H) are able to be in any number, such as one, two, three, four, and more. In some embodiments, the lower layer coil 124 is able to be the second arm 108B of first coil 108 and the upper layer 111 is able to be the first arm 111 of the 7^{th} coil if 2^{nd} to 6^{th} coil are installed in sequence according to the procedure described above.

In some embodiments, each unit of the coil block (such as unit 124A) comprises a rectangular coil block, such as coil block 126K. For example, the windings can be wound from a wire having a rectangular cross section. The size of the coil block 126K is able to be pre-determined by the numbers of turns per coil to meet a voltage requirement. In some embodiments, a thin coil block 126K is preferred to decrease the skin effect in the conductor. In some embodiments, the size of the coil block 126K is 5-6 mm in its width and 0.5 mm or thinner in its thickness, such as 0.1 mm to 0.3 mm. The length of the coil block 126K is able to be determined by the thickness of the stator.

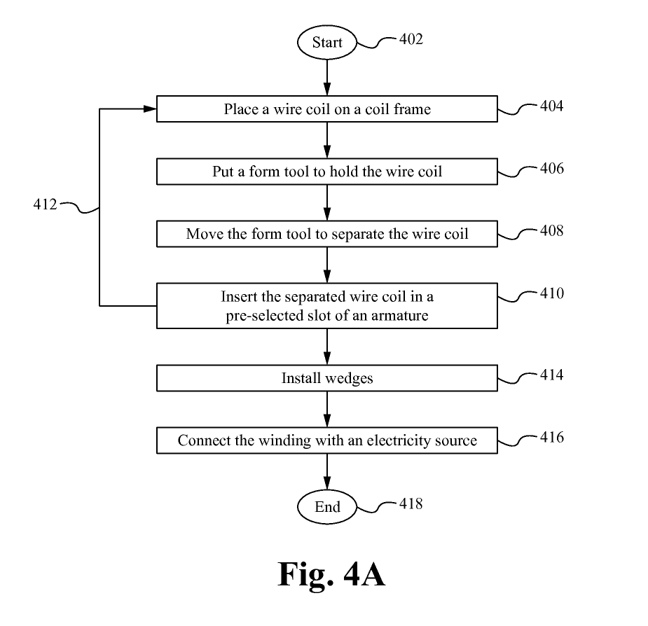

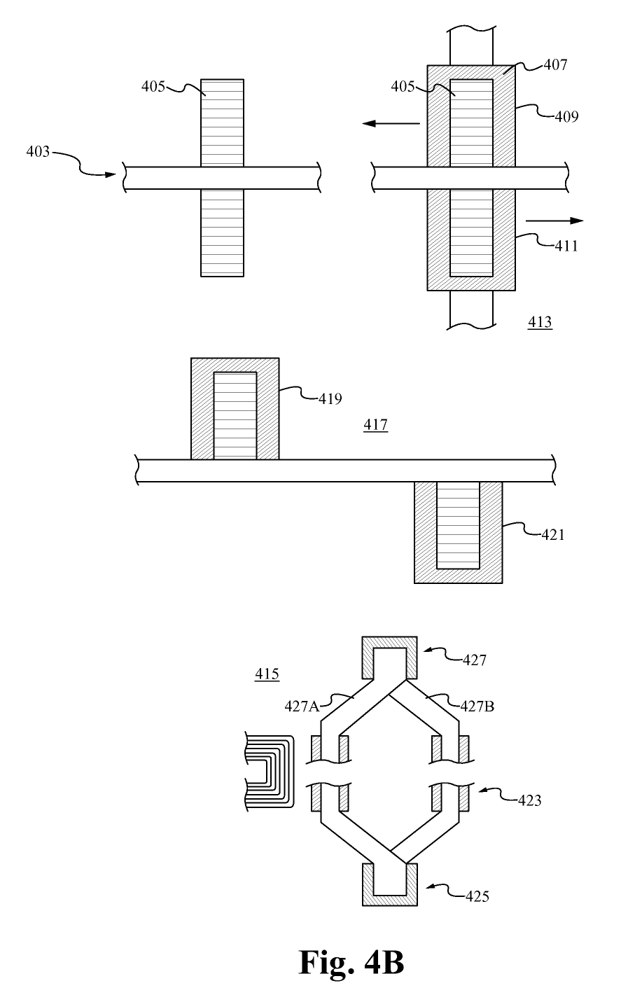

FIG. 4A illustrates a winding manufacturing method 400 in accordance with some embodiments. FIG. 4B illustrates a device for manufacturing the winding in accordance with some embodiments. FIG. 4A is able to be read in conjunction with FIG. 4B. The method 400 is able to begin from the Step 402. At the Step 404, wire coils 405 are placed on a coil frame 403. The wire coils 405 are able to be in a form of insulated square winding. At the Step 406, a form tool 407 is used to hold the wire coils 405. The form tool 407 is able to hold the top surface of the wire coil 409 and subsequently hold the bottom surface of the wire coil 411. The form tool 407 is placed on both sides of the end turn part as shown 413 and 415. As shown in FIG. 4B, the coil end turns at ends 425 and 427. The first coil arm 427A and the second coil arm 427B are able to be twisted ends similar to the first and second coil arms 110A and 110B (FIG. 1), respectively. At the Step 408, the form tool 407 is moved apart to separate the wire coil. In some embodiments, the form tool 407 is moved in a lateral opposite direction, such that the wire coil is able to be separated into a first part 419 and a second part 421. At the Step 410, the separated wire coil is inserted in a pre-selected slot of an armature. The coil used herein is able to be pre-insulated with varnish paint or cohered by epoxy or varnish paint before inserted into the slots. The Steps 404-410 are able to be a repeated cycle for preparing one loop of the wire coil for inserting into the armature. The Step 412 is able to repeat the Step 404 to the Step 410, such that multiple wire coils are able to be made and inserted into the slots of the armature. At the Step 414, wedges are installed to close the slot openings of the armature with the windings described above. The wedges 310 in the FIG. 3 are inserted to hold the winding/coils in place. At the Step 416, the coils are able to be coupled with an electricity source. The method ends at the Step 418.

In some embodiments, the wedges are able to be semi-magnetic wedges to decrease an equivalent air gap, so that the power factor of the motor is able to be improved, especially in an induction motor application. In some embodiments, factors and parameters are considered in the motor design including air gap, slot leakage induction, and a combination thereof. These factors are able to be calculated and balanced to design an efficient motor.

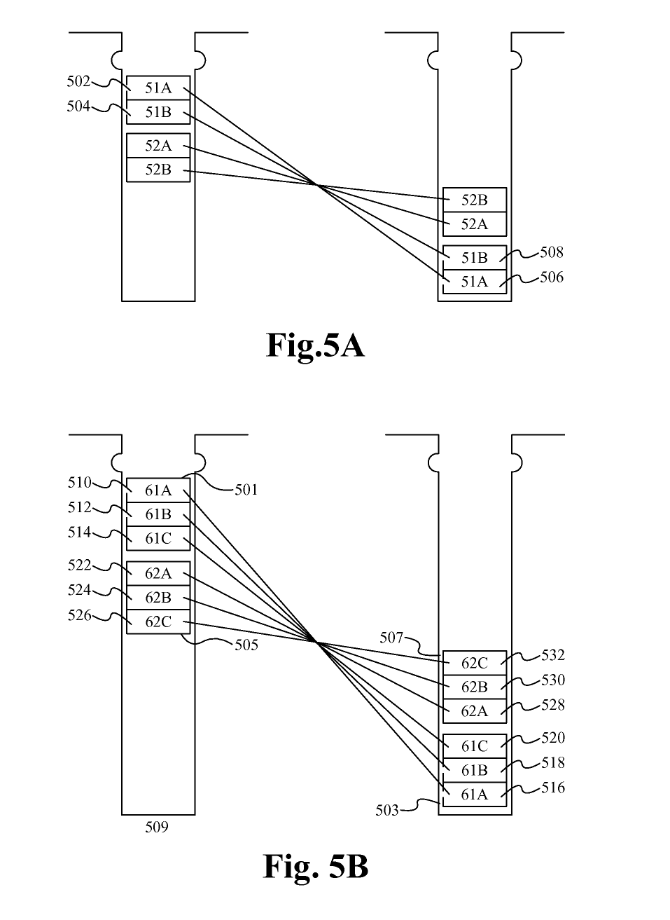

FIG. 5A illustrates a two strand winding design in accordance with some embodiments. In some embodiments, multiple strands rectangular copper wire with insulating enamel is provided to decrease skin effect in the conductor. The strands of the same coil are able to reverse their respective vertical positions when the coil is placed in different slots. For example as shown in FIG. 5A, each of the conductor has two strands (blocks), 51A and 51B, at the left side of the coil. The strand 51A at the position 502 has less slot leakage inductance than that of the strand 51B at the position 504, because the position 502 is higher than the position 504. After a fully position transfer (phase turning), the strand 51A is located at the lower position 506 than the strand 51B, which is located at the higher position 508. The leakage inductance 51A at the position 502 and at the position 506 is equal to the leakage inductance 51B at the position 504 and at the position 508 because of slot leakage linear distribution along the slot. The position transferring makes current distribution uniformly and make minimum circulating currents between strands are some of the advantageous aspects of the present invention.

FIG. 5B illustrates a three strand winding design in accordance with some embodiments. The three strands winding design is able to contain a first block 501 having three strands 61A, 61B, 61C. The three strands winding design is able to contain a second block 505 having three strands 62A, 62B, and 62C. Similar to the design described in FIG. 5A, the three strands in FIG. 5B are fully position transferred. After position transferring, the three strands 61A, 61B, and 61C at the first block 501 with position 510, 512, and 514 become located at the position 520, 518, and 516 of the block position 503. Similarly after position transferring, the three strands 62A, 62B, and 62C at the first block 505 with position 522, 524, and 526 become located at the position 528, 530, and 532 respectively of the block position 507.

The present invention is able to be utilized to improve the motor efficiency for the electric vehicles that runs fully or partially on batteries and for all motors. In the operation of a motor manufacturing plant, the windings/coils are able to be pre-formed and be placed into the open slots of the armature to form a lapped double layer winding. Comparing to the typical partial closed opening/slot design, the present invention provides advantageous aspects. For example, the typical partial closed opening/slot design requires a worker to push the winding into the partial closed slot one by one, and the typical design would take up significant time for manufacturing a motor. In comparison, the present invention has open slots, so the manufacturing workers are able to directly put the coils/windings into the open slots without pushing through the narrower bottleneck design at the opening. Further, the thin winding block design of the present invention is able to reduce the skin effect when the windings are charged with electricity at function. Moreover, the position transferred/phase turning coil (the winding is twisted and turned upside down at the end turn) makes current distribution more uniformly and makes minimum circulating currents between the strands.

The term “open slot” is able to include a fully open slot (without bottleneck that is narrower at the opening) of the stator.

All steps described above are optional. The sequence of performing the steps that are included in the methods above is able to be in any orders. Additional steps are able to be added.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims

What is claimed is:

1. A motor comprising:
a. a stator having a first open slot and a second open slot;
b. a double layered winding structure having a first coil side of a first winding at a bottom position and a first coil side of a second winding at a top position of the first open slot; and
c. a first end turn comprising a turned phase winding structure, wherein the first end turn is electrically coupled with the first coil side of the first winding and a second coil side of the first winding.

2. The motor of claim 1, wherein each of the first winding and the second winding comprise multiple conductors forming a multiple turn winding, wherein each of the conductors comprises multiple strands.

3. The motor of claim 1, wherein the second coil side of the first winding is positioned at a top position of the second open slot.

4. The motor of claim 3, further comprising a third winding having a first coil side at a bottom position of the second open slot.

5. The motor of claim 3, further comprising a third open slot having a second coil side of the second winding positioned at a bottom position of the third open slot.

6. The motor of claim 1, wherein the stator comprises multiple slots surrounding the stator in a circle.

7. The motor of claim 1, wherein the first winding is twisted and turned up-side-down at the first end turn.

8. The motor of claim 7, further comprising a second end turn connecting the first coil side of the first winding and the second coil side of the first winding forming a loop structure.

9. The motor of claim 1, further comprising a wedge covering an opening of the first open slot, the second open slot, the third open slot, or a combination thereof.

10. The motor of claim 9, wherein the wedge is made of plastic, polymers, bamboo, aluminum, a semi-magnetic material, or a combination thereof.

11. The motor of claim 10, wherein the semi-magnetic material comprises epoxy and powdered steel.

12. A motor comprising:
a. a stator comprising a first open slot; and
b. a first coil in the first open slot, wherein the first coil forms at least one block.

13. The motor of claim 12, wherein the block is substantially rectangular in shape.

14. The motor of claim 12, wherein the first coil forms a first block and a second block.

15. The motor of claim 14, wherein the first block is on top of the second block in the first open slot.

16. The motor of claim 15, wherein the first block and the second block are reverse in position when the first coil is positioned in a different open slot.

17. The motor of claim 12, further comprising a second coil.

18. The motor of claim 17, wherein the second coil is on top of the first coil in the first open slot.

19. The motor of claim 17, further comprising a separator between the first coil and the second coil.

20. The motor of claim 12, further comprising a wedge covering the opening of the first opening slot.

21. The motor of claim 20, wherein the wedge is made of plastic, polymers, bamboo, aluminum, a semi-magnetic material, or a combination thereof.

22. The motor of claim 12, wherein the thickness of the block is reduced to reduce a skin effect.

23. A method of manufacturing a motor comprising:
a. placing a first coil in a lower position of a first open slot; and
b. placing a second coil in a higher position of the first open slot.

24. The method of claim 23, wherein the first coil is in a higher position of a second open slot.

25. The method of claim 23, wherein the second coil is in a lower position of a third open slot.

26. The method of claim 23, wherein the first coil is formed before placing in the first open slot.

27. The method of claim 23 further comprising placing a third coil in a lower position of an open slot immediate adjacent to the first open slot.

28. The method of claim 23, wherein the motor comprises multiple open slots surrounding a stator of the motor.

29. The method of claim 28, wherein the open slots comprise fully opening slots.
